(19) United States
(12) Patent Application Publication
(10) Pub. No.: US 2026/0116821 A1
(43) Pub. Date: Apr. 30, 2026

(54) METHOD, APPARATUS, DEVICE, AND MEDIUM FOR SIMULATINGPOLYURETHANE PERMEATION GROUTING DIFFUSION

(71) Applicant: Sun Yat-sen University, Guangzhou (CN)

(72) Inventors: Dingfeng CAO, Guangzhou (CN); Jiajia ZHENG, Guangzhou (CN); Chengchao GUO, Guangzhou (CN); Fuming WANG, Guangzhou (CN); Fan YANG, Guangzhou (CN); Lei QIN, Guangzhou (CN); Feifan SHI, Guangzhou (CN); Zhichuang SHI, Guangzhou (CN)

(21) Appl. No.: 18/999,089

(22) Filed: Dec. 23, 2024

(30) Foreign Application Priority Data
Oct. 24, 2024 (CN) 202411493801.6

(51) Int. Cl. C04B 26/16; C04B 111/00; C04B 111/70; G06N 7/00

(52) U.S. Cl. CPC C04B 26/16; G06N 7/00; C04B 2111/00198; C04B 2111/00991; C04B 2111/70

(57) ABSTRACT

A method for simulating polyurethane permeation grouting diffusion includes constructing a geometric model of permeation grouting diffusion of polyurethane in a porous medium to be injected based on physical property data of the porous medium to be injected; establishing a physical field of the geometric model using a Richards equation and a dilute species transport equation for a porous medium, and adjusting the geometric model based on a material property parameter of the geometric model obtained based on the physical field; setting a boundary condition and an initial value for an adjusted geometric model, and performing mesh division on the adjusted geometric model based on a local refinement method to obtain a simulation model for permeation grouting diffusion; and solving the simulation model for permeation grouting diffusion using a transient solver to complete the simulation of permeation grouting diffusion of the polyurethane in the porous medium to be injected.

### CROSS-REFERENCE TO RELATED APPLICATION

This application claims priority to Chinese Patent Application No. CN 202411493801.6, filed on Oct. 24, 2024, the disclosure of which is incorporated herein by reference in its entirety.

### TECHNICAL FIELD

The present application relates to the field of geotechnical engineering, in particular, a method, apparatus, device, and medium for simulating polyurethane permeation grouting diffusion.

### BACKGROUND

Grouting has long been the most effective method for preventing and controlling water inrush in underground engineering. The grouting methods in the related art may be divided into permeation grouting, fracture grouting, and hydraulic fracturing grouting based on the diffusion patterns of grout in the injected medium. Permeation grouting refers to the permeation of grout in porous media, where the grout only seeps through the pores. Different from the construction method of traditional cement-based grouting materials, chemical grouting materials need to be evenly mixed using a static mixer. Once the grout is injected into the stratum, the viscosity begins to change. The viscosity of the grout injected earlier has already increased for some time, while the viscosity of the newly injected grout has only just started to increase. This results in varying viscosities of the grout at different locations. Therefore, it is necessary to consider the temporal and spatial variation characteristics of grout viscosity.

However, the related art faces challenges in accurately reflecting the complex physical structures and variations when constructing permeation grouting diffusion models, which leads to discrepancies between simulation results and actual conditions.

### SUMMARY

The present application aims to provide a method, apparatus, device, and medium for simulating polyurethane permeation grouting diffusion to improve the modeling accuracy of the grout diffusion process.

To solve the preceding problems, an embodiment of the present application provides a method for simulating polyurethane permeation grouting diffusion. The method includes steps described below.

A geometric model of permeation grouting diffusion of polyurethane in a porous medium to be injected is constructed based on physical property data of the porous medium to be injected.

A physical field of the geometric model is established using the Richards equation and a dilute species transport equation for a porous medium, and the geometric model is adjusted based on a material property parameter of the geometric model obtained based on the physical field, where the physical field reflects the influence of the material property of the polyurethane on the seepage diffusion process.

A boundary condition and an initial value are set for an adjusted geometric model, and mesh division is performed on the adjusted geometric model based on a local refinement method to obtain a simulation model for permeation grouting diffusion.

The simulation model for permeation grouting diffusion is solved using a transient solver to complete the simulation of permeation grouting diffusion of the polyurethane in the porous medium to be injected.

Another embodiment of the present application provides an apparatus for simulating polyurethane permeation grouting diffusion. The apparatus includes a construction module, an assignment module, a division module, and a calculation module.

The construction module is configured to construct a geometric model of permeation grouting diffusion of polyurethane in a porous medium to be injected based on physical property data of the porous medium to be injected.

The assignment module is configured to establish a physical field of the geometric model using the Richards equation and a dilute species transport equation for a porous medium and adjust the geometric model based on a material property parameter of the geometric model obtained based on the physical field, where the physical field reflects the influence of the material property of the polyurethane on the seepage diffusion process.

The division module is configured to set a boundary condition and an initial value for an adjusted geometric model and perform mesh division on the adjusted geometric model based on a local refinement method to obtain a simulation model for permeation grouting diffusion.

The calculation module is configured to solve the simulation model for permeation grouting diffusion using a transient solver to complete the simulation of permeation grouting diffusion of the polyurethane in the porous medium to be injected.

Another embodiment of the present application provides a computer device. The device includes a memory, a processor, and a computer program stored in the memory and executable on the processor. When executing the computer program, the processor implements the preceding method for simulating polyurethane permeation grouting diffusion.

Another embodiment of the present application provides a computer-readable storage medium storing a computer program. When the device where the computer-readable storage medium is located executes the computer program, the preceding method for simulating polyurethane permeation grouting diffusion is implemented.

### BRIEF DESCRIPTION OF DRAWINGS

FIG. 1 is a flowchart of a method for simulating polyurethane permeation grouting diffusion according to an embodiment of the present application.

FIG. 2 is a diagram of the mesh division of a grouting geometric model according to an embodiment of the present application.

FIG. 3 is a diagram illustrating the structure of an apparatus for simulating polyurethane permeation grouting diffusion according to an embodiment of the present application.

FIG. 4 is a diagram illustrating the structure of a device for simulating polyurethane permeation grouting diffusion according to an embodiment of the present application.

### DETAILED DESCRIPTION

The technical solutions in the embodiments of the present application are described clearly and completely in conjunction with the drawing in the embodiments of the present application. Apparently, the embodiments described below are part, not all, of the embodiments of the present application. The purpose of providing these embodiments is to make the disclosure of the present application more thorough and comprehensive. Based on the embodiments of the present application, all other embodiments obtained by those of ordinary skill in the art without creative work are within the scope of the present application. In the description of the present application, terms like “first”, “second”, and “third” are for description only and are not to be construed as indicating or implying relative importance or implicitly indicating the number of technical features as indicated. Thus, features defined as “first”, “second”, “third”, and the like may explicitly or implicitly include one or more of the features. In the description of the present application, unless otherwise noted, “a plurality of” means two or more.

In the description of the present application, it should be noted that unless otherwise expressly specified and limited, terms such as “mounted”, “connected to each other”, and “connected” are to be construed in a broad sense, for example, as permanently connected, detachably connected, or integrally connected; mechanically connected or electrically connected; directly connected or indirectly connected via an intermediate medium; or internally connected of two elements. The terms “vertical”, “horizontal”, “left”, “right”, “up”, “down”, and similar expressions used herein are for illustrative purposes only and do not indicate or imply that the referred apparatus or element has a specific orientation and is constructed and operated in a specific orientation, and thus it is not to be construed as limiting the present application. The term “and/or” used herein includes any or all combinations of one or more listed associated items. For those of ordinary skill in the art, specific meanings of the preceding terms in the present application can be construed depending on specific contexts.

In the description of the present application, it should be noted that unless otherwise defined, all technical and scientific terms used in the present application have the meanings commonly understood by those skilled in the art. The terms used in the specification of the present application are only for the purpose of describing specific embodiments and are not intended to limit the present application. For those of ordinary skill in the art, specific meanings of the preceding terms in the present application can be construed depending on specific contexts.

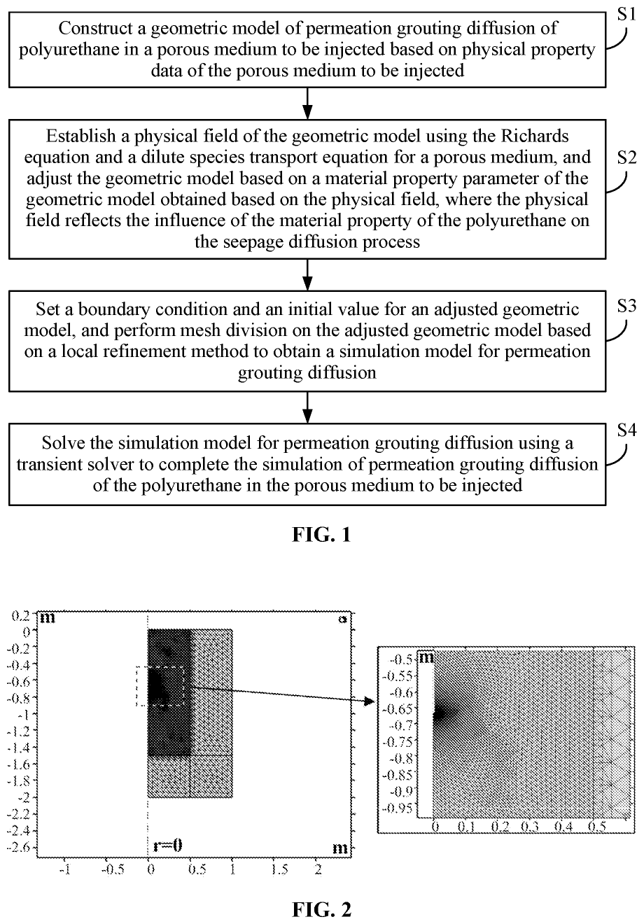

An embodiment of the present application provides a method for simulating polyurethane permeation grouting diffusion according to an embodiment of the present application. For details, reference is made to FIG. 1, which shows a flowchart of a method for simulating polyurethane permeation grouting diffusion according to an embodiment of the present application. The method includes S1 to S4.

In S1, a geometric model of permeation grouting diffusion of polyurethane in a porous medium to be injected is constructed based on physical property data of the porous medium to be injected.

In S2, a physical field of the geometric model is established using the Richards equation and a dilute species transport equation for a porous medium, and the geometric model is adjusted based on a material property parameter of the geometric model obtained based on the physical field, where the physical field reflects the influence of the material property of the polyurethane on the seepage diffusion process.

In S3, a boundary condition and an initial value are set for an adjusted geometric model, and mesh division is performed on the adjusted geometric model based on a local refinement method to obtain a simulation model for permeation grouting diffusion.

In S4, the simulation model for permeation grouting diffusion is solved using a transient solver to complete the simulation of permeation grouting diffusion of the polyurethane in the porous medium to be injected.

It should be noted that in the related art, the effects of gravity and the temporal and spatial variation characteristics of grout viscosity are not considered during the permeation of grout in a porous medium. Additionally, the inherent heterogeneity of seepage channels within the porous medium is also overlooked. Due to the time-varying viscosity of the grout, solidified particles, during the grouting process as the grout diffuses, gradually form and fill the pores in the porous medium, reducing the original permeability. To address the preceding shortcomings, the present application provides a method for modeling permeation grouting that better meets the practical requirements of grouting engineering.

Assuming the porous medium is isotropic, the permeation and diffusion process of grout can be intuitively understood through a sectional view of the stratum. Therefore, the grouting model may be simplified into a two-dimensional model in an axisymmetric form. The vertical axis on the left side serves as an axis of symmetry. An infinite element domain is added to the right and bottom of the cross-section, with a thickness of 0.5*R1 and a cylindrical type. Thus, the polyurethane can freely exit the soil column, reducing the impact of artificial boundaries on the target region. The constructed geometric model is a spherical diffusion model of polyurethane permeation grouting in a porous medium. In this model, the porous medium is set to a region with a radius of R1 and a height of H1, where R1=1 m and H1=2 m, and the grouting pipe has a radius of r1 and a height of h1, where r1=5 cm and h1=0.6 m.

In an embodiment of the present application, constructing the geometric model of permeation grouting diffusion of the polyurethane in the porous medium to be injected based on the physical property data of the porous medium to be injected includes converting, based on a cross-section method, the permeation grouting diffusion process of the polyurethane in the porous medium to be injected into a two-dimensional representation to obtain a two-dimensional model of permeation grouting; determining a geometric parameter of the two-dimensional model based on the physical property data of the porous medium to be injected; and constructing the geometric model of the polyurethane in the porous medium to be injected based on an infinite source domain method and the geometric parameter.

In an embodiment, the infinite source domain method is a mathematical model used to simulate the flow and diffusion of fluids in porous media. This method assumes that the fluid source is infinite and that the flow and diffusion of the fluids in the porous media are continuous. Using the infinite source domain method and determined geometric parameters, a geometric model of polyurethane in a porous medium is constructed. In the model, the process of polyurethane grout gradually diffusing and permeating into the porous medium from the grouting port should be accurately reflected.

Polyurethane undergoes permeation and diffusion in an unsaturated porous medium, with the seepage and diffusion process simulated using a Richards equation module and a module of transport of a dilute species in a porous medium. During the permeation process, the pressure field in the porous medium may be expressed as follows:

$$\begin{matrix}ρ ( {S}_{e} {S}_{p} + \frac{{C}_{m}}{ρ g} ) \frac{\partial p}{\partial t} + ∇ \cdot ( ρ u ) = {Q}_{m} \\ u = - \frac{{κ}_{s} {κ}_{r}}{μ} ( ∇ p + ρ g )\end{matrix} .$$

In the formula, p denotes pore water pressure (Pa), Sₑ denotes effective saturation (−), Sₚ denotes water storage coefficient (1/Pa), Cₘ denotes moisture capacity (1/m), p denotes fluid density (kg/m³), g denotes gravitational acceleration (m/s²), ∇ denotes Hamiltonian operator, u denotes fluid velocity, kₛ denotes hydraulic conductivity (m²), μ denotes dynamic viscosity of fluid (Pa·s), Kr denotes relative permeability (−), and Qₘ denotes fluid source term or sink term (kg/(m³·s)).

During the diffusion process, the concentration field of the grout may be expressed as follows:

$$\begin{matrix}\frac{\partial ( θ {C}_{i} )}{\partial t} + \frac{\partial ( ρ {c}_{p , i} )}{\partial t} + ∇ \cdot {J}_{i} + u \cdot ∇ {c}_{i} = {R}_{i} + {S}_{i} \\ {J}_{i} = - ( {D}_{D , i} + {D}_{e , i} ) ∇ {c}_{i}\end{matrix} .$$

In the formula, θ denotes volumetric water content (m³/m³), cᵢ denotes concentration of each substance in the solution (mol/m³), p denotes solution density (kg/m³), c_{p,i} denotes adsorption concentration on soil particles (mol/kg), u denotes fluid velocity (m/s), D_{D,i} denotes the dispersion tensor (m²/s), D_{e,i} denotes an effective diffusion coefficient (m²/s), Rᵢ denotes a physico-chemical reaction term (mol/(m².s)), and Sᵢ denotes a source and sink term (mol/(m²·s)).

In an embodiment of the present application, adjusting the geometric model based on the material property parameter of the geometric model obtained based on the physical field includes constructing a diffusion model based on the Newtonian fluid rheological equation and a seepage motion equation; acquiring a stage-specific permeability function of the polyurethane in the porous medium to be injected based on the diffusion model; acquiring dynamic viscosity of the polyurethane during a permeation grouting diffusion process in the porous medium to be injected through a rheological experiment; and adjusting the geometric model using the permeability function and the dynamic viscosity as material property parameters of the geometric model.

According to the physical field, material properties and parameters to be assigned are determined, as described in Table 1 and Table 2.

TABLE 1
User-defined diffusion model

| Parameter | Value | Description |
|---|---|---|
| R₁ (m) | 1 | Radius of the porous |
| | | medium region |
| H₁ (m) | 2 | Height of the porous |
| | | medium region |
| r₁(cm) | 5 | Radius of the |
| | | grouting pipe |
| h₁(m) | 0.6 | Length of the |
| | | grouting pipe |
| d(mm) | 5 | Pore diameter |
| t₀(s) | 1800 | Grout curing time |
| C₀(mol/m³) | 1 | Grout concentration |
| p(kPa) | 50 | Grouting pressure |
| δ | 0.45 | Void ratio |
| poro | 0.41 | Porosity |

TABLE 2
Material parameters of polyurethane and porous medium

| Parameter | Value | Description |
|---|---|---|
| rho0/(kg/m³) | 1100 | Fluid density |
| rhob(kg/m³) | 1700 | Porous medium |
| | | density |
| mu | antl(t) | Dynamic viscosity |
| kappas | pwl(t) | Permeability |

In an embodiment, it is assumed that polyurethane undergoes a permeation and diffusion process in the porous medium, and the following conditions are satisfied:
1. Static pressure grouting is used, and the pressure loss from the grouting pipe to the pipe mouth and the velocity loss during the diffusion process are ignored.
2. The grout is an incompressible and isotropic Newtonian fluid that satisfies Darcy's law during the diffusion process.
3. Throughout the entire permeation process, the grout permeates in the form of laminar flow and does not mix with groundwater, resulting in a complete displacement process.
4. The porous medium does not undergo displacement during grout permeation, displacement, and solidification.
5. The porous medium to be injected is uniform and isotropic.

The fundamental rheological equation of a Newtonian fluid may be expressed as follows:

$$τ = μ \cdot γ . \qquad ( 1 )$$

In the formula, τ denotes the shear force, that is, the internal friction force per unit area of the grout (Pa), μ denotes dynamic viscosity (mPa·s), γ=−dv/dr denotes the shear rate (s⁻¹), and v and r denote the seepage velocity of the fluid in the pore channel and the geometric distance perpendicular to the flow direction of the grout, respectively. In actual engineering, the grout gradually solidifies upon reaction with water, and the viscosity of the grout changes over time. The time-varying law of the viscosity is usually expressed in the form of an exponential function, that is,

$$\begin{matrix}μ ( t ) = {C}_{1} \cdot {e}^{kt} + {μ}_{0} & 0 \leq t \leq {t}_{2} .\end{matrix} \qquad ( 2 )$$

In the formula, μ(t) denotes the function of dynamic viscosity and time (mPa·s), measurable through rheological tests, μ₀ denotes initial viscosity of the grout, t denotes time(s), t₂ denotes liquid-solid phase transition time of the grout(s), k denotes a time-varying coefficient, and C₁ denotes a constant. To simplify the calculation, the viscosity integral median is used to determine the diffusion radius of the grout considering the time-varying viscosity, that is,

$$μ = \frac{{\int }_{0}^{t} ( {C}_{1} \cdot {e}^{kt} + {μ}_{0} ) dt}{t} . \qquad ( 3 )$$

For the laminar flow state of the Newtonian fluid in the porous medium, a microelement is taken for analysis with the pipe axis as the symmetry axis on the flow path. It is assumed that the radius of the circular pipe is r₀, the microelement radius r>r₀, and the length is dl. The pressures on the left and right sections of the microelement are p and p+dp respectively, and the shear force on the upper and lower surfaces of the microelement is t. Considering gravity, the equilibrium condition of the force on the microelement is as follows:

$$p π {r}^{2} - ( p + dp ) π {r}^{2} = 2 π r τ dl + π {r}^{2} dl \cdot ρ g sin θ - \frac{π}{2} \leq θ \leq \frac{π}{2} . \qquad ( 4 )$$

In the formula, θ denotes the angle between the grout diffusion direction and the grouting pipe. When the diffusion direction is upward relative to the horizontal plane, the angle is positive; when the diffusion direction is downward relative to the horizontal plane, the angle is negative. After simplification, the following is obtained:

$$τ = - \frac{r}{2} ( \frac{dp}{dl} + ρ g sin θ ) . \qquad ( 5 )$$

(5) is substituted into (1), the following is obtained:

$$\frac{d v}{d r} = \frac{r}{2 \overline{μ}} ( \frac{dp}{d l} + ρ g sin θ ) . \qquad ( 6 )$$

Now (6) is integrated, and the boundary conditions that r=r₀ and v=0 are substituted to obtain the following:

$$v = - \frac{{r}_{0}^{2} - {r}^{2}}{4 \overline{μ}} ( \frac{dp}{d l} + ρ g sin θ ) . \qquad ( 7 )$$

Thus, when the grout moves in a single circular pipe during laminar motion, the total flow rate in the pipe is as follows:

$${q}_{0} = {\int }_{0}^{{r}_{0}} 2 π r v d r = - \frac{π {r}_{0}^{4}}{8 \overline{μ}} ( \frac{dp}{d l} + ρ g si n θ ) . \qquad ( 8 )$$

Assuming the porous medium contains Ni capillaries with a radius of rᵢ, the total flow rate of grout in the porous medium is as follows:

$$q = - \frac{π}{8 \overline{μ}} ( \frac{dp}{d l} + ρ g sin θ ) \cdot {\sum }_{i = 1}^{N} {N}_{i} {r}_{i}^{4} . \qquad ( 9 )$$

In actual pores of the porous medium, the capillary channels are random and non-uniform. The tortuosity may be used to characterize the tortuous effects of fluid particle motion and diffusion, and the definition is as follows:

$$χ = {( \frac{{L}_{t}}{{L}_{0}} )}^{2} . \qquad ( 10 )$$

In the formula, Lₜ denotes the actual length of the grout flowing through the porous medium channel, L₀ denotes the diffusion distance between the grouting hole and the grout front, and χ denotes physical tortuosity. Therefore, the total flow rate of grout in the porous medium may be transformed into the following:

$$q = - \frac{π}{8 \overline{μ}} ( \frac{1}{\sqrt{χ}} \cdot \frac{dp}{d {L}_{0}} + ρ g sin θ ) \cdot {\sum }_{i = 1}^{N} {N}_{i} {r}_{i}^{4} . \qquad ( 11 )$$

Based on the Bruggeman model, the relationship between physical tortuosity and geometric tortuosity is given as follows:

$$χ = {χ}_{g} {ϕ}^{0.1} . \qquad ( 12 )$$

χ_{g} denotes geometric porosity, which may be determined through image analysis combined with the pore centroid method. Porosity may be expressed as follows:

$$ϕ = \frac{{\sum }_{i = 1}^{N} {N}_{i} π {r}_{i}^{2}}{A} . \qquad ( 13 )$$

In the formula, A=4πR² denotes the area of the diffusion region in the porous medium. Since the seepage velocity V=Q/A, then

$$V = - \frac{ϕ}{8 \overline{μ}} ( \frac{1}{\sqrt{χ}} \cdot \frac{dp}{d {L}_{0}} + ρ g sin θ ) \frac{{\sum }_{i = 1}^{N} {N}_{i} {r}_{i}^{4}}{{\sum }_{i = 1}^{N} {N}_{i} {r}_{i}^{2}} . \qquad ( 14 )$$

The effective permeability of the stratum is as follows:

$$K = \frac{ϕ}{8} \cdot \frac{{\sum }_{i = 1}^{N} {N}_{i} {r}_{i}^{4}}{{\sum }_{i = 1}^{N} {N}_{i} {r}_{i}^{2}} . \qquad ( 15 )$$

Finally, the Newtonian fluid seepage motion equation is obtained as follows:

$$V = - \frac{K}{μ} ( \frac{1}{\sqrt{{χ}_{g} {ϕ}^{0.1}}} . \frac{dp}{d {L}_{0}} + ρ g sin θ ) . \qquad ( 16 )$$

Based on the Newtonian fluid rheological equation and the seepage motion equation, combined with rheological experiments, the specific permeability function and dynamic viscosity can be acquired.

In an embodiment of the present application, the permeability function is expressed as follows:

$$p w l ( t ) = \{ \begin{matrix}\frac{3}{16} \cdot \frac{ϕ}{1 - ϕ} \cdot {δ}^{2} \cdot ( 1 - \frac{2}{4 - ln \frac{ρ R ϕ δ}{3 t \cdot \overline{u}}} ) & t \leq {t}_{1} \\ \frac{ϕ}{8} \cdot {d}^{2} & {t}_{1} < t \leq {t}_{2} \\ {K}_{0} \cdot {( \frac{ϕ}{{ϕ}_{0}} )}^{3} \cdot {( \frac{1 - {ϕ}_{0}}{1 - ϕ} )}^{2} & t > {t}_{2}\end{matrix} .$$

In the formula, pwl(t) denotes permeability, φ denotes porosity, d denotes pore diameter, t denotes permeation time, t₁ denotes the time when the flow resistance disappears, t₂ denotes grout curing time, δ denotes void ratio, ρ denotes grout density, R denotes porous medium radius, μ̅ is an integral median of a function for the dynamic viscosity and the permeation time, and φ₀ and K₀ each denotes porosity under an initial effective stress condition.

In an embodiment of the present application, the dynamic viscosity is expressed as follows:

$$μ ( t ) = {C}_{1} \cdot {e}^{kt} + {μ}_{0} 0 \leq t \leq {t}_{2} .$$

In the formula, μ(t) denotes the function of the dynamic viscosity and time, μ₀ denotes initial viscosity of grout, t denotes the time, t₂ denotes fluid-solid phase transition time of the grout, k denotes a time-varying coefficient, and C₁ denotes a constant.

In an embodiment, the dynamic viscosity measured through rheological experiments is as follows:

$$ant 1 = 32.51 * exp ( 0.0027 * t ) .$$

After the material property parameters are set, the boundary condition and initial value are determined. In the present application, pressure boundary conditions are set. Considering gravity, the initial pressure value is set to −(z+H1), the pressure head is set to rho0/(1000 [kg/m\hat{ }2]*(−g_const)), the bottom and right infinite element domain boundaries are set to permeable layers, and the external head is −2 m. Next, concentration boundary conditions are set. The initial concentration value is set to 0, the concentration is set to c0, and the outflow boundary is set to 0.

In an embodiment of the present application, performing mesh division on the adjusted geometric model based on the local refinement method to obtain the simulation model for permeation grouting diffusion includes: performing a preliminary mesh division on the adjusted geometric model to obtain a sparse mesh; identifying key regions in the sparse mesh based on a simulation requirement of the geometric model, where the key regions at least include a grouting pipe region and an interior region of the porous medium; and performing secondary mesh densification on the key regions using the local refinement method to obtain the simulation model for permeation grouting diffusion.

In an embodiment, reference is made to FIG. 2, which shows a diagram of the mesh division of a grouting geometric model according to an embodiment of the present application. The model is meshed by user-controlled mesh, free quadrilateral mesh, and local refinement. Local refinement is applied to perform secondary mesh densification in the vicinity of the grouting pipe. By specifying the boundary, the mesh densification region is defined as r (0, 0.5*R¹) and z (−0.5*H1, 0).

In an embodiment of the present application, solving the simulation model for permeation grouting diffusion using the transient solver to complete the simulation of permeation grouting diffusion of the polyurethane in the porous medium to be injected includes setting a partial differential equation corresponding to the permeation grouting diffusion process of the polyurethane in the porous medium to be injected based on a Newtonian fluid rheological equation and a seepage motion equation; discretizing a time term in the partial differential equation using an implicit Euler backward difference method to obtain a discretized partial differential equation; and inputting the discretized partial differential equation into a pre-constructed transient solver for solving, and simulating the permeation grouting diffusion process of the polyurethane in the porous medium by adjusting the number of iterations and the time step of the transient solver.

In an embodiment, a transient solver is employed for calculation, with a time step of 5 s and a total simulation time of 3600 s. It should be noted that during the simulation process, coefficient-based partial differential equations built into the simulation software are assigned as needed, and thus various types of partial differential equations can be obtained. After the coefficients are assigned, numerical values may be used to solve the equations. The time terms in the equations are discretized using the implicit Euler backward difference method, and the equations are solved using the nonlinear iterative corrected damped Newton method.

Finally, the data is visualized to complete the permeation grouting diffusion process.

In addition, the present application also provides a method for determining the permeation grouting spherical diffusion radius of polyurethane permeation grouting. During the initial phase of grouting, the grout is significantly affected by flow resistance, and the permeability gradually increases. As the flow stabilizes, the grout is in a purely fluid state or flow-plastic state, where the permeation process may be considered as permeation with constant permeability. As the grouting progresses, the rheological properties of the grout gradually change from a fluid-solid phase transition stage to a solidified state, at the diffusion front, a solidified grout ring gradually forms and spreads in the porous medium under the influence of grouting pressure, and the permeability of the porous medium decreases gradually until the permeability reaches zero. Therefore, the present application divides the grout diffusion in the permeation process into three stages, that is, permeation diffusion, stable grouting, and phase transition solidification.

### 1. Permeation Diffusion Stage

During the grouting time t, the grout diffusion radius is R, and the grouting volume is expressed as follows:

$$Q = \frac{4}{3} π {R}^{3} \cdot ϕ . \qquad ( 17 )$$

The grouting volume required within the grouting time t is equal to the amount of grout needed to flow through the pores in the diffusion region during this period. Thus, the grouting volume may also be expressed as follows:

$$Q = VA \cdot t . \qquad ( 18 )$$

By combining (16) and (17), the pressure gradient in the polyurethane permeation region is obtained as follows:

$$\frac{dp}{{dL}_{0}} = - \sqrt{χ} ( \frac{Q \overline{μ}}{4 π {R}^{2} Kt} + ρ ℊ sin θ ) . \qquad ( 19 )$$

Outside the grout permeation front, pressure decay is much smaller than that inside the grout permeation front. It can be considered that the pressure outside the grout permeation front is constant, and the pressure at the front position is continuous with the external pressure (p=p₀). In the initial stage of grouting, the permeability in the porous medium varies with the grout flow rate due to fluid inertia. Iberall derives the permeability expression for the porous medium based on a flow resistance model, that is,

$$K = \frac{3}{16} \cdot \frac{ϕ}{1 - ϕ} \cdot {δ}^{2} \cdot \frac{2 - ln Re}{4 - ln Re} and , \qquad ( 20 )$$

$$RE = \frac{ρ V δ}{\overline{μ}} . \qquad ( 21 )$$

In the formulas, Re denotes the Reynolds number, ρ denotes grout density, and δ denotes the initial pore diameter of the porous medium. (17), (18), (20), and (21) are combined, and thus permeability of the stratum may be expressed as follows:

$${K}_{1} ( t ) = \frac{3}{16} \cdot \frac{ϕ}{1 - ϕ} \cdot {δ}^{2} \cdot ( 1 - \frac{2}{4 - ln \frac{ρ R ϕδ}{3 t \cdot \overline{μ}}} ) . \qquad ( 22 )$$

It is assumed that the radius of the grouting pipe is r, and the boundary conditions of the grouting pressure are considered. That is, when p=p₀, L₀=r; when p=p₁, L₀=R₁. In the formulas, p₁ and R₁ denote the pressure at the grouting point and the diffusion distance of the grout at the grouting time t₀, respectively. (19) and (22) are combined, the boundary conditions are substituted, and variable separation and integration are performed after substitution. Thus, the diffusion control equation of permeation grouting considering permeability effects may be expressed as follows:

$${p}_{1} - {p}_{0} = \frac{\sqrt{χ} Q \overline{μ}}{3 {K}_{1} ( t ) {t}_{0}} ( \frac{1}{{R}_{1}} - \frac{1}{r} ) - ( {R}_{1} - r ) ρ ℊ sin θ . \qquad ( 23 )$$

In the formula, p₀ denotes constant pressure outside the grout permeation front.

### 2. Steady Grouting Stage

As the permeation grouting process gradually stabilizes, both the grout flow rate and the permeability K₂ of the porous medium reach a constant value, where K₂=K₀.

Considering the boundary conditions of the grouting pressure, when p=p₀, L₀=r; when p=p₂, L₀=R₂. In the formulas, p₂ and R₂ denote the pressure at the grouting point and the diffusion distance of the grout at the grouting time t₁, respectively. (19) and (22) are combined, and variable separation and integration are performed after substitution. Thus, the grout diffusion radius control equation is as follows:

$${p}_{2} - {p}_{0} = \frac{\sqrt{χ} Q \overline{μ}}{3 {K}_{2} ( t ) {t}_{1}} ( \frac{1}{{R}_{2}} - \frac{1}{r} ) - ( {R}_{2} - r ) ρ ℊ sin θ . \qquad ( 24 )$$

### 3. Phase-Transition Solidification Stage

When the grouting time reaches the phase-transition end time t₀, the grout enters a phase-transition solidification stage. During the breakthrough of the grout front solidification ring, the polyurethane particles formed after solidification gradually fill the pores of the porous medium due to the seepage effect, reducing the original permeability. As the grout front forms a new solidified layer, the permeability of the porous medium decreases and gradually approaches 0.

The change in porosity is the primary cause of changes in permeability. The change law of porosity during grouting is as follows:

$$ϕ = {ϕ}_{r} + ( {ϕ}_{0} - {ϕ}_{r} ) {e}^{- {ασ}_{e}} . \qquad ( 25 )$$

In the formula, φ₀ denotes porosity under the initial effective stress condition, φᵣ denotes porosity of the porous medium measured under a consolidation and drainage condition,
   σₑ denotes the average effective stress (MPa), and α denotes the compression coefficient (MPa⁻¹). The Kozeny-Carman model is used to describe the change in permeability, that is,

$${K}_{3} = {K}_{0} \cdot {( \frac{ϕ}{{ϕ}_{0}} )}^{3} \cdot {( \frac{1 - {ϕ}_{0}}{1 - ϕ} )}^{2} . \qquad ( 26 )$$

Considering the boundary conditions of the grouting pressure, when p=p₀, L₀=r; when p=p₃, L₀=R₃. In the formulas, p₃ and R₃ denote the pressure at the grouting point and the diffusion distance of the grout at the grouting time t₂, respectively. (19) and (22) are combined, and variable separation and integration are performed after substitution. Thus, the grout diffusion radius control equation is as follows:

$${p}_{3} - {p}_{0} = \frac{\sqrt{χ} Q \overline{μ}}{3 {K}_{3} ( t ) {t}_{2}} ( \frac{1}{{R}_{3}} - \frac{1}{r} ) - ( {R}_{3} - r ) ρ ℊ sin θ . \qquad ( 27 )$$

Compared to the related art, the beneficial effects of the embodiments of the present application include at least the following aspects:
1. In the present application, a geometric model is constructed based on the actual physical structure and properties of the porous medium, which can more realistically reflect the complexity and irregularity of the porous medium, thereby improving the accuracy of the simulation; a physical field is established using the Richards equation and a dilute species transport equation for a porous medium, where these two equations describe the unsaturated seepage and species transport processes of fluids in the porous medium, respectively, thereby enabling a more accurate reflection of the seepage and diffusion behavior of polyurethane in the porous medium.
2. Through simulating the seepage and diffusion behavior of different polyurethane materials in the porous medium, the present application can evaluate the permeability, diffusivity, and other properties of materials, thus providing a basis for material selection and design.
3. Through numerical simulation, the present application can rapidly evaluate the advantages and disadvantages of different grouting solutions or material solutions, thereby improving decision-making efficiency.

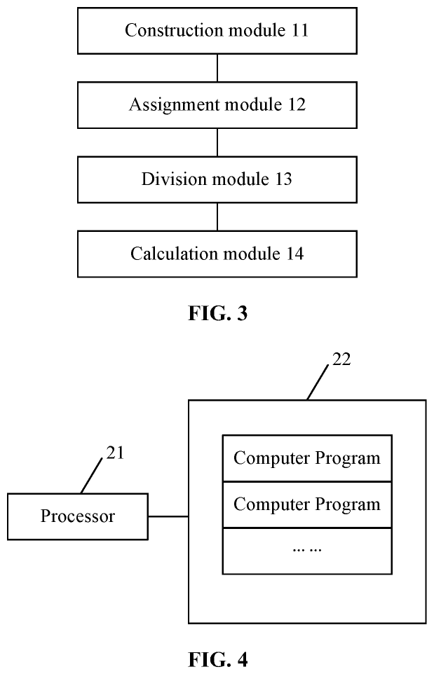

Another embodiment of the present application provides an apparatus for simulating polyurethane permeation grouting diffusion. For details, reference is made to FIG. 3, which shows a diagram illustrating the structure of an apparatus for simulating polyurethane permeation grouting diffusion according to an embodiment of the present application. The apparatus includes a construction module 11, an assignment module 12, a division module 13, and a calculation module 14.

The construction module 11 is configured to construct a geometric model of permeation grouting diffusion of polyurethane in a porous medium to be injected based on physical property data of the porous medium to be injected.

The assignment module 12 is configured to establish a physical field of the geometric model using the Richards equation and a dilute species transport equation for a porous medium and adjust the geometric model based on a material property parameter of the geometric model obtained based on the physical field, where the physical field reflects the influence of the material property of the polyurethane on the seepage diffusion process.

The division module 13 is configured to set a boundary condition and an initial value for an adjusted geometric model and perform mesh division on the adjusted geometric model based on a local refinement method to obtain a simulation model for permeation grouting diffusion.

The calculation module 14 is configured to solve the simulation model for permcation grouting diffusion using a transient solver to complete the simulation of permeation grouting diffusion of the polyurethane in the porous medium to be injected.

Another embodiment of the present application provides a device for simulating polyurethane permeation grouting diffusion. The device includes a processor 21, a memory 22, and a computer program stored in the memory 22 and configured to be executed by the processor 21. When executing the computer program, the processor 21 implements the steps in the embodiments of the preceding method for simulating polyurethane permeation grouting diffusion, such as steps S1 to S4 described in FIG. 1; or when executing the computer program, the processor 21 implements the functions of each module in the preceding apparatus embodiments, such as the construction module 11.

Exemplarily, the computer program may be divided into one or more modules, and the one or more modules are stored in the memory 22 and executed by the processor 21 to implement the present application. The one or more modules may be a series of computer program instruction segments that are configured to perform specific functions. These instruction segments are used to describe the execution process of the computer program in the device for simulating polyurethane permeation grouting diffusion. For example, the computer program may be divided into a construction module 11, an assignment module 12, a division module 13, and a calculation module 14.

The processor 21 may be a central processing unit (CPU), a general-purpose processor, a digital signal processor (DSP), an application specific integrated circuit (ASIC), a field-programmable (FPGA), or other programmable logic devices, discrete gates or transistor logic devices, or discrete hardware components. A general-purpose processor may be a microprocessor or any conventional processor. The processor 21 serves as the control center of the device for simulating polyurethane permeation grouting diffusion and connects various parts of the device through interfaces and circuits.

The memory 22 may store the computer program and/or modules. The processor 21, by running or executing the computer program and/or modules stored in the memory 22 and invoking the data stored in the memory 22, achieves various functions of the device for simulating polyurethane permeation grouting diffusion. The memory 22 may mainly include a program storage region and a data storage region. The program storage region may store an operating system and an application required for at least one function (such as a sound playback function and an image playback function). The data storage region may store data (such as audio data and a phone book) and the like created based on the use of a mobile phone. In addition, the memory 22 may include a high-speed random-access memory (RAM) and a non-volatile memory, such as a hard drive, a memory, a plug-in hard drive, a smart media card (SMC), a secure digital (SD) card, a flash card, at least one magnetic disk storage device, a flash memory device, or other non-volatile solid-state storage devices.

If the modules integrated in the device for simulating polyurethane permeation grouting diffusion are implemented as software functional units and sold or used as independent products, the modules may be stored in a computer-readable storage medium. Based on this understanding, all or part of the processes in the preceding method embodiments implemented by the present application may also be implemented by instructing relevant hardware through a computer program. The computer program may be stored in a computer-readable storage medium, and when executed by a processor, the computer program may perform the steps of the various method embodiments described above. The computer program includes computer program that may be in the form of source code, object code, executable files, or intermediate forms. The computer-readable medium may include any entity or apparatus capable of carrying the computer program code, a recording medium, a USB drive, a portable hard drive, a magnetic disk, an optical disk, a computer memory, a read-only memory (ROM), a random access memory (RAM), an electrical carrier signal, a telecommunication signal, and a software distribution medium, among others.

Those of ordinary skill in the art may understand that all or part of the processes in the preceding method embodiments can be implemented by instructing related hardware through a computer program. The program may be stored in a computer-readable storage medium. When the program is executed, the processes of the preceding method embodiments may be included. The storage medium may be a magnetic disk, an optical disk, a read-only memory (ROM), a random access memory (RAM), or the like.

Accordingly, an embodiment of the present application provides a computer-readable storage medium. The medium includes a stored computer program. The computer program, when running, controls the device where the computer-readable storage medium is located to execute the steps in the method for simulating polyurethane permeation grouting diffusion according to the preceding embodiments, such as steps S1 to S4 described in FIG. 1.

The preceding embodiments are only several embodiments of the present application. These embodiments are described in a specific and detailed manner but cannot be understood as a limit to the scope of the present application. It is to be noted that for those skilled in the art, a number of improvements and modifications can be made without departing from the principle concept of the present application, and these improvements and modifications are within the scope of the present application. Therefore, the scope of the present application is defined by the appended claims.

What is claimed is:

1. A method for simulating polyurethane permeation grouting diffusion, comprising:
constructing a geometric model of permeation grouting diffusion of polyurethane in a porous medium to be injected based on physical property data of the porous medium to be injected;
establishing a physical field of the geometric model using a Richards equation and a dilute species transport equation for a porous medium, and adjusting the geometric model based on a material property parameter of the geometric model obtained based on the physical field, wherein the physical field reflects an influence of a material property of the polyurethane on a seepage diffusion process;
setting a boundary condition and an initial value for an adjusted geometric model, and performing mesh division on the adjusted geometric model based on a local refinement method to obtain a simulation model for permeation grouting diffusion; and
solving the simulation model for permeation grouting diffusion using a transient solver to complete a simulation of permeation grouting diffusion of the polyurethane in the porous medium to be injected.

2. The method for simulating polyurethane permeation grouting diffusion according to claim 1, wherein adjusting the geometric model based on the material property parameter of the geometric model obtained based on the physical field comprises:
constructing a diffusion model based on a Newtonian fluid rheological equation and a seepage motion equation;
acquiring a stage-specific permeability function of the polyurethane in the porous medium to be injected based on the diffusion model;
acquiring dynamic viscosity of the polyurethane during a permeation grouting diffusion process in the porous medium to be injected through a rheological experiment; and
adjusting the geometric model using the permeability function and the dynamic viscosity as material property parameters of the geometric model.

3. The method for simulating polyurethane permeation grouting diffusion according to claim 2, wherein the permeability function is expressed as:
$$pwl ( t ) = \{ \begin{matrix}\frac{3}{16} \cdot \frac{ϕ}{1 - ϕ} \cdot {δ}^{2} \cdot ( 1 - \frac{2}{4 - ln \frac{ρ R ϕδ}{3 t \cdot \overline{μ}}} ) & t \leq {t}_{1} \\ \frac{ϕ}{8} \cdot {d}^{2} & {t}_{1} < t \leq {t}_{2} ; \\ {K}_{0} \cdot {( \frac{ϕ}{{ϕ}_{0}} )}^{3} \cdot {( \frac{1 - {ϕ}_{0}}{1 - ϕ} )}^{2} & t > {t}_{2}\end{matrix}$$
wherein pwl(t) denotes permeability, ø denotes porosity, d denotes pore diameter, t denotes permeation time, t₁ denotes the time when the flow resistance disappears, t₂ denotes grout curing time, δ denotes void ratio, p denotes grout density, R denotes porous medium radius, μ̅ is an integral median of a function for the dynamic viscosity and the permeation time, and φ₀ and K₀ each denotes porosity under an initial effective stress condition.

4. The method for simulating polyurethane permeation grouting diffusion according to claim 2, wherein the dynamic viscosity is expressed as:
$$μ ( t ) = {C}_{1} \cdot {e}^{kt} + {μ}_{0} 0 \leq t \leq {t}_{2} ;$$
wherein μ(t) denotes a function of the dynamic viscosity and time, ulo denotes initial viscosity of grout, t denotes the time, t₂ denotes fluid-solid phase transition time of the grout, k denotes a time-varying coefficient, and C₁ denotes a constant.

5. The method for simulating polyurethane permeation grouting diffusion according to claim 1, wherein constructing the geometric model of permeation grouting diffusion of the polyurethane in the porous medium to be injected based on the physical property data of the porous medium to be injected comprises:
converting, based on a cross-section method, a permeation grouting diffusion process of the polyurethane in the porous medium to be injected into a two-dimensional representation to obtain a two-dimensional model of permeation grouting;
determining a geometric parameter of the two-dimensional model based on the physical property data of the porous medium to be injected; and
constructing the geometric model of the polyurethane in the porous medium to be injected based on an infinite source domain method and the geometric parameter.

6. The method for simulating polyurethane permeation grouting diffusion according to claim 1, wherein performing mesh division on the adjusted geometric model based on the local refinement method to obtain the simulation model for permeation grouting diffusion comprises:
performing a preliminary mesh division on the adjusted geometric model to obtain a sparse mesh;
identifying key regions in the sparse mesh based on a simulation requirement of the geometric model, wherein the key regions at least comprise a grouting pipe region and an interior region of the porous medium; and
performing secondary mesh densification on the key regions using the local refinement method to obtain the simulation model for permeation grouting diffusion.

7. The method for simulating polyurethane permeation grouting diffusion according to claim 1, wherein solving the simulation model for permeation grouting diffusion using the transient solver to complete the simulation of permeation grouting diffusion of the polyurethane in the porous medium to be injected comprises:
setting a partial differential equation corresponding to a permeation grouting diffusion process of the polyurethane in the porous medium to be injected based on a Newtonian fluid rheological equation and a seepage motion equation;
discretizing a time term in the partial differential equation using an implicit Euler backward difference method to obtain a discretized partial differential equation; and
inputting the discretized partial differential equation into a pre-constructed transient solver for solving, and simulating the permeation grouting diffusion process of the polyurethane in the porous medium by adjusting a number of iterations and a time step of the transient solver.

8. A device for simulating polyurethane permeation grouting diffusion, comprising a memory, a processor, and a computer program stored in the memory and executable on the processor, wherein when executing the computer program, the processor implements the following steps:
constructing a geometric model of permeation grouting diffusion of polyurethane in a porous medium to be injected based on physical property data of the porous medium to be injected;
establishing a physical field of the geometric model using a Richards equation and a dilute species transport equation for a porous medium, and adjusting the geometric model based on a material property parameter of the geometric model obtained based on the physical field, wherein the physical field reflects an influence of a material property of the polyurethane on a seepage diffusion process;
setting a boundary condition and an initial value for an adjusted geometric model, and performing mesh division on the adjusted geometric model based on a local refinement method to obtain a simulation model for permeation grouting diffusion; and
solving the simulation model for permeation grouting diffusion using a transient solver to complete a simulation of permeation grouting diffusion of the polyurethane in the porous medium to be injected.

9. The device according to claim 8, wherein adjusting the geometric model based on the material property parameter of the geometric model obtained based on the physical field comprises:
constructing a diffusion model based on a Newtonian fluid rheological equation and a seepage motion equation;
acquiring a stage-specific permeability function of the polyurethane in the porous medium to be injected based on the diffusion model;
acquiring dynamic viscosity of the polyurethane during a permeation grouting diffusion process in the porous medium to be injected through a rheological experiment; and
adjusting the geometric model using the permeability function and the dynamic viscosity as material property parameters of the geometric model.

10. The device according to claim 9, wherein the permeability function is expressed as:
$$pwl ( t ) = \{ \begin{matrix}\frac{3}{16} \cdot \frac{ϕ}{1 - ϕ} \cdot {δ}^{2} \cdot ( 1 - \frac{2}{4 - ln \frac{ρ R ϕδ}{3 t \cdot \overline{μ}}} ) & t \leq {t}_{1} \\ \frac{ϕ}{8} \cdot {d}^{2} & {t}_{1} < t \leq {t}_{2} ; \\ {K}_{0} \cdot {( \frac{ϕ}{{ϕ}_{0}} )}^{3} \cdot {( \frac{1 - {ϕ}_{0}}{1 - ϕ} )}^{2} & t > {t}_{2}\end{matrix}$$
wherein pwl(t) denotes permeability, φ denotes porosity, d denotes pore diameter, t denotes permeation time, t₁ denotes the time when the flow resistance disappears, t₂ denotes grout curing time, δ denotes void ratio, ρ denotes grout density, R denotes porous medium radius, μ̅ is an integral median of a function for the dynamic viscosity and the permeation time, and φ₀ and K₀ each denotes porosity under an initial effective stress condition.

11. The device according to claim 9, wherein the dynamic viscosity is expressed as:
$$μ ( t ) = {C}_{1} \cdot {e}^{kt} + {μ}_{0} 0 \leq t \leq {t}_{2} ;$$
wherein μ(t) denotes a function of the dynamic viscosity and time, μ₀ denotes initial viscosity of grout, t denotes the time, t₂ denotes fluid-solid phase transition time of the grout, k denotes a time-varying coefficient, and C₁ denotes a constant.

12. The device according to claim 8, wherein constructing the geometric model of permeation grouting diffusion of the polyurethane in the porous medium to be injected based on the physical property data of the porous medium to be injected comprises:
converting, based on a cross-section method, a permeation grouting diffusion process of the polyurethane in the porous medium to be injected into a two-dimensional representation to obtain a two-dimensional model of permeation grouting;
determining a geometric parameter of the two-dimensional model based on the physical property data of the porous medium to be injected; and
constructing the geometric model of the polyurethane in the porous medium to be injected based on an infinite source domain method and the geometric parameter.

13. The device according to claim 8, wherein performing mesh division on the adjusted geometric model based on the local refinement method to obtain the simulation model for permeation grouting diffusion comprises:
performing a preliminary mesh division on the adjusted geometric model to obtain a sparse mesh;
identifying key regions in the sparse mesh based on a simulation requirement of the geometric model, wherein the key regions at least comprise a grouting pipe region and an interior region of the porous medium; and
performing secondary mesh densification on the key regions using the local refinement method to obtain the simulation model for permeation grouting diffusion.

14. The device according to claim 8, wherein solving the simulation model for permeation grouting diffusion using the transient solver to complete the simulation of permeation grouting diffusion of the polyurethane in the porous medium to be injected comprises:
setting a partial differential equation corresponding to a permeation grouting diffusion process of the polyurethane in the porous medium to be injected based on a Newtonian fluid rheological equation and a seepage motion equation;
discretizing a time term in the partial differential equation using an implicit Euler backward difference method to obtain a discretized partial differential equation; and
inputting the discretized partial differential equation into a pre-constructed transient solver for solving, and simulating the permeation grouting diffusion process of the polyurethane in the porous medium by adjusting a number of iterations and a time step of the transient solver.

15. A non-transitory computer-readable storage medium storing a computer program that, when executed by a processor, implements the following steps:
constructing a geometric model of permeation grouting diffusion of polyurethane in a porous medium to be injected based on physical property data of the porous medium to be injected;
establishing a physical field of the geometric model using a Richards equation and a dilute species transport equation for a porous medium, and adjusting the geometric model based on a material property parameter of the geometric model obtained based on the physical field, wherein the physical field reflects an influence of a material property of the polyurethane on a seepage diffusion process;
setting a boundary condition and an initial value for an adjusted geometric model, and performing mesh division on the adjusted geometric model based on a local refinement method to obtain a simulation model for permeation grouting diffusion; and
solving the simulation model for permeation grouting diffusion using a transient solver to complete a simulation of permeation grouting diffusion of the polyurethane in the porous medium to be injected.

16. The storage medium according to claim 15, wherein adjusting the geometric model based on the material property parameter of the geometric model obtained based on the physical field comprises:
constructing a diffusion model based on a Newtonian fluid rheological equation and a seepage motion equation;
acquiring a stage-specific permeability function of the polyurethane in the porous medium to be injected based on the diffusion model;
acquiring dynamic viscosity of the polyurethane during a permeation grouting diffusion process in the porous medium to be injected through a rheological experiment; and
adjusting the geometric model using the permeability function and the dynamic viscosity as material property parameters of the geometric model.

17. The storage medium according to claim 16, wherein the permeability function is expressed as:
$$pwl ( t ) = \{ \begin{matrix}\frac{3}{16} \cdot \frac{ϕ}{1 - ϕ} \cdot {δ}^{2} \cdot ( 1 - \frac{2}{4 - ln \frac{ρ R ϕδ}{3 t \cdot \overline{μ}}} ) & t \leq {t}_{1} \\ \frac{ϕ}{8} \cdot {d}^{2} & {t}_{1} < t \leq {t}_{2} ; \\ {K}_{0} \cdot {( \frac{ϕ}{{ϕ}_{0}} )}^{3} \cdot {( \frac{1 - {ϕ}_{0}}{1 - ϕ} )}^{2} & t > {t}_{2}\end{matrix}$$
wherein pwl(t) denotes permeability, ø denotes porosity, d denotes pore diameter, t denotes permeation time, t₁ denotes the time when the flow resistance disappears, t₂ denotes grout curing time, δ denotes void ratio, ρ denotes grout density, R denotes porous medium radius, μ̅ is an integral median of a function for the dynamic viscosity and the permeation time, and φ₀ and K₀ each denotes porosity under an initial effective stress condition.

18. The storage medium according to claim 16, wherein the dynamic viscosity is expressed as:
$$μ ( t ) = {C}_{1} \cdot {e}^{kt} + {μ}_{0} 0 \leq t \leq {t}_{2} ;$$
wherein μ(t) denotes a function of the dynamic viscosity and time, p₀ denotes initial viscosity of grout, t denotes the time, t₂ denotes fluid-solid phase transition time of the grout, k denotes a time-varying coefficient, and C₁ denotes a constant.

19. The storage medium according to claim 15, wherein constructing the geometric model of permeation grouting diffusion of the polyurethane in the porous medium to be injected based on the physical property data of the porous medium to be injected comprises:
converting, based on a cross-section method, a permeation grouting diffusion process of the polyurethane in the porous medium to be injected into a two-dimensional representation to obtain a two-dimensional model of permeation grouting;
determining a geometric parameter of the two-dimensional model based on the physical property data of the porous medium to be injected; and
constructing the geometric model of the polyurethane in the porous medium to be injected based on an infinite source domain method and the geometric parameter.

20. The storage medium according to claim 15, wherein performing mesh division on the adjusted geometric model based on the local refinement method to obtain the simulation model for permeation grouting diffusion comprises:
performing a preliminary mesh division on the adjusted geometric model to obtain a sparse mesh;
identifying key regions in the sparse mesh based on a simulation requirement of the geometric model, wherein the key regions at least comprise a grouting pipe region and an interior region of the porous medium; and
performing secondary mesh densification on the key regions using the local refinement method to obtain the simulation model for permeation grouting diffusion.
